(19) United States
(12) Patent Application Publication
(10) Pub. No.: US 2016/0348859 A1
(43) Pub. Date: Dec. 1, 2016

(54) STRIP LIGHT AND LIGHTING DEVICE APPLICATION THEREOF

(71) Applicants: YU-NAN WANG, Taoyuan (TW); YAO-CHING TSAI, Taoyuan (TW)

(72) Inventor: YU-NAN WANG, Taoyuan (TW)

(21) Appl. No.: 14/721,050

(22) Filed: May 26, 2015

(51) Int. Cl. F21S 4/00; F21K 99/00

(52) U.S. Cl. CPC F21S 4/008; F21K 9/56; F21Y 2103/003

(57) ABSTRACT

A strip light of the present invention consists of at least one light emitting diode mounted on a transparent baseplate. In addition, a protective layer covers the transparent baseplate and each of the light emitting diodes. A fluorescent layer covers the periphery of the protective layer, and a uniform light layer covers the periphery of the fluorescent layer, thereby achieving the strip light that is able to produce a 360-degree omnidirectional light emitting effect, and further enabling the strip lights to be adapted to form light panels, light modules, or even light bulbs for application in different product models of lighting devices.

### BACKGROUND OF THE INVENTION

(a) Field of the Invention

The present invention relates to a strip light and lighting device application thereof, and more particularly to a LED (light emitting diode) lighting device provided with LED strip lights and application thereof.

(b) Description of the Prior Art

A light emitting diode (LED) is a semiconductor component able to convert an electric current into light of specific wavelength range, and the advantages of the light emitting diode, including high brightness, low operating voltage, small power consumption, easy matching in integrated circuits, simple actuation, and long operating life, enable the LED to serve as a light source, and has extensive application in the lighting field.

Wherein, a light emitting diode strip light is a light-emitting component with light emitting diodes arranged in a linear configuration. Because of easy production and low cost, application of light emitting diodes has gradually expanded. Light emitting diode strip lights of the prior art primarily comprise a baseplate in the form of a long strip, with a plurality of light emitting diodes mounted on the baseplate. The plurality of light emitting diodes mounted on the surface of the baseplate enable achieving a light emitting diode strip light with predetermined length specifications.

Furthermore, the baseplates used by traditional light emitting diode strip lights mainly include aluminum baseplates and copper foil baseplates. In use, a single light emitting diode strip light is installed and applied in an apparatus, or a variable number of the light emitting diode light strips are connected in series to increase the length of the light source.

Nevertheless, light emitting diode strip lights similar to those of the prior art only enable installation using a linear method, moreover, use is limited to a structural design whereby the light emitting diodes are mounted on a single side of the baseplate, which only enables the light sources to illuminate a single direction. Moreover, the angle of illumination is relatively limited, and thus unable to effectively increase the range of application of the light emitting diode strip light.

### SUMMARY OF THE INVENTION

In light of this, the primary objective of the present invention is to provide a strip light able to produce an omnidirectional light source illumination effect and lighting device application thereof.

In order to achieve the aforementioned objective, a strip light of the present invention basically comprises: a transparent baseplate, which is a flexible baseplate having light transmittance; at least one light emitting diode, which are fixedly mounted to the transparent baseplate through at least one conductive film; a protective layer, which correspondingly covers the transparent baseplate and the periphery of each of the light emitting diodes, the protective layer being formed by hardening a first plasticized material having light transmittance; a fluorescent layer, which correspondingly covers the periphery of the protective layer, the fluorescent layer being made up from fluorescent powder; and a uniform light layer, which correspondingly covers the periphery of the fluorescent layer, the uniform light layer being formed by hardening a second plasticized material having light transmittance.

Using the aforementioned technological characteristics, when in use, the strip light of the present invention is connected to a power source through the conductive film. When an electric current flows through the light emitting diodes, under the auxiliary effect of the fluorescent layer and the uniform light layer, the light sources of the light emitting diodes are able to outwardly illuminate toward the complete periphery of the protective layer, thereby producing a 360-degree omnidirectional light emitting effect.

The lighting device disclosed in the present invention basically comprises: a light holder, at least one strip light is mounted on the light holder, and each of the strip lights is provided with at least one light emitting diode mounted on a transparent baseplate, each of the light emitting diodes is fixedly mounted on the transparent baseplate through at least one conductive film, in addition, the protective layer, which is formed by hardening a first plasticized material having light transmittance, covers the transparent baseplate and the periphery of each of the light emitting diodes, the fluorescent layer, which is made up from fluorescent powder, covers the periphery of the protective layer, and the uniform light layer, which is formed by hardening a second plasticized material having light transmittance, covers the periphery of the fluorescent layer, at least one photoelectric component is fixedly mounted on the periphery of the uniform light layer, and at least one thermoelectric component is fixedly mounted on the periphery of the uniform light layer; a control module, which is electrically connected to each of the light emitting diodes, each of the photoelectric components, and each of the thermoelectric components to enable connecting to an external power source and the power sources produced by each of the photoelectric components and each of the thermoelectric components, the control module further controls whether or not an electric current flows through each of the light emitting diodes.

Using the aforementioned technological characteristics enables achieving a lighting device capable of producing a 360-degree omnidirectional light emitting effect from the strip lights. Moreover, the lighting device is further able, under the integrated operation of the control module and each of the photoelectric components and each of the thermoelectric components, to recover and convert the light energy and heat energy produced by the light emitting diodes into electrical energy to supply that required for the lighting device to operate.

Specifically, apart from providing a 360-degree omnidirectional light source illumination effect, the strip lights disclosed by the present invention can be further adapted to present non-linear structural configurations, whereby the strip lights are configured to form light panels, light modules, or even light bulbs for application in different product models of lighting devices. In particular, through the integrated operation of each of the photoelectric components, each of the thermoelectric components, and the electric power storage module, light energy and heat energy produced by the light emitting diodes are recovered and converted into electrical energy to supply that required for the lighting device to operate, which further accentuates the energy saving and power saving effectiveness of the lighting device.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a cut-away view depicting the structure of a strip light of a first embodiment of the present invention.

FIG. 2 is a cut-away view depicting the cross-sectional structure of the strip light of a second embodiment of the present invention.

FIG. 3 is a structural view of a lighting device of a first embodiment mode of the present invention.

FIG. 4 is a structural view of a lighting device of a second embodiment mode of the present invention.

FIG. 5 is a structural view of a lighting device of a third embodiment mode of the present invention.

FIG. 6 is a schematic view depicting a structural configuration of the strip light of the present invention.

FIG. 7 is a schematic view depicting another structural configuration of the strip light of the present invention.

### DETAILED DESCRIPTION OF THE PREFERRED EMBODIMENTS

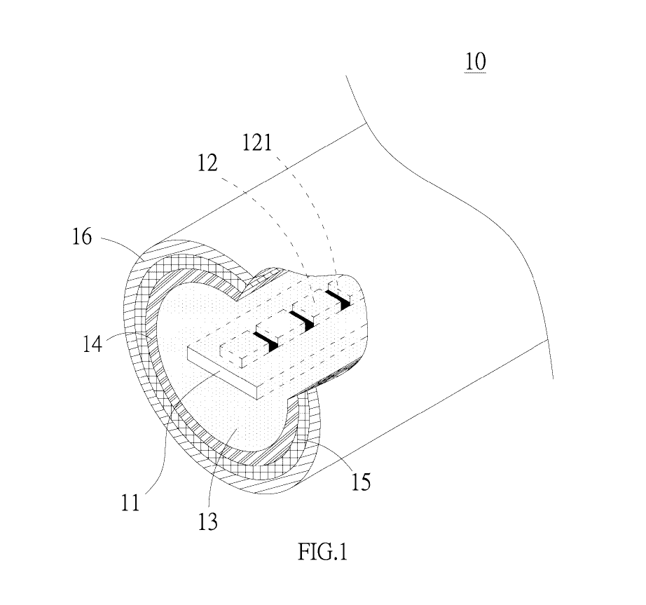

The present invention primarily provides a strip light able to produce an omnidirectional light source illumination effect and lighting device application thereof. Referring to FIG. 1, which shows a strip light 10 of the present invention basically comprising: a transparent baseplate 11, at least one light emitting diode 12, a protective layer 13, a fluorescent layer 14, and a uniform light layer 15, wherein:

The transparent baseplate 11 is a flexible baseplate having light transmittance, and primarily serves as a mechanical structure main body to bear the weight of the light emitting diodes 12. In actual use, the material of the aforementioned transparent baseplate 11 is selected from either a gallium nitride baseplate or a sapphire baseplate.

Each of the light emitting diodes 12 is fixedly mounted on the transparent baseplate 11 through at least one conductive film 121. Moreover, each of the aforementioned light emitting diodes 12 is a semiconductor wafer cutting, and the aforementioned conductive film 121 is an indium tin oxide having light transmittance. In actual use, each of the light emitting diodes 12 is further die bonded to the transparent baseplate 11 through wafer bonding, and the die bond can use either direct bonding or glue bonding.

The protective layer 13 correspondingly covers the transparent baseplate 11 and the periphery of each of the light emitting diodes 12. The protective layer 13 is formed by hardening a first plasticized material having light transmittance, and is primarily used to fixedly position the transparent baseplate 11 and achieve an assembled structure of each of the light emitting diodes 12, and further create a shielding effect for the transparent baseplate 11 and each of the light emitting diodes 12. In actual use, the aforementioned protective layer 13 can be formed by hardening silicone.

The fluorescent layer 14 is formed from fluorescent powder and correspondingly covers the periphery of the protective layer 13. The fluorescent powder is primarily used to produce a light amplification reaction with the light sources of the light emitting diodes 12 to achieve the expectant light color appearance effect.

The uniform light layer 15 correspondingly covers the periphery of the fluorescent layer 14. The uniform light layer 15 is formed by hardening a second plasticized material having light transmittance. In actual use, the aforementioned uniform light layer 15 can be formed by hardening silicone. It is understood that fluorescent powder can be further added to the aforementioned uniform light layer 15 to produce a second light amplification reaction.

In principle, when in use, the strip light 10 of the present invention is connected to a power source through the conductive film 121. And when electric current is flowing through the light emitting diodes 12, under the auxiliary effect of the fluorescent layer 14 and the uniform light layer 15, the light sources of the light emitting diodes 12 are able to outwardly illuminate toward the complete periphery of the protective layer 13, thereby producing an omnidirectional 360-degree light emitting effect. In addition, the protective layer 13 is formed by hardening a first plasticized material, wherein the first plasticized material can be either silicone or resin; and the uniform light layer 15 is formed by hardening a second plasticized material, wherein the second plasticized material can be either silicone or optical material. Moreover, the first plasticized material and the second plasticized material can be the same material. It is understood that the first plasticized material and the second plasticized material can be heterogeneous materials to further provide the strip light 10 with increased effectiveness including: 1. Enable adaption for application in different model variations to facilitate setting up wafer encapsulated structural configurations. 2. Increase light transmittance to reduce light attenuation coefficient. 3. Increase auto-thermal emission effectiveness and heat dissipation speed. 4. Improve and increase light source excitation, reduce and block the amount of blue light radiation, and achieve more uniform and moderate light source irradiation. 5. Increase color rendering.

Furthermore, in the strip light 10 of the present invention, a light transmitting material 16 can further cover the periphery of the uniform light layer 15. And the light transmitting material 16 is used to augment the strength and reliability of the structure of the entire strip light 10. In actual use, the aforementioned light transmitting material 16 is made from either glass or silicon. In addition, the entire strip light 10 is provided with at least one photoelectric component 17, which converts light energy into electric energy, fixedly mounted on the periphery of the uniform light layer 15, or is provided with at least one thermoelectric component 18, which converts heat energy into electric energy, fixedly mounted on the periphery of the uniform light layer 15

It is understood that in the entire strip light 10, as shown in the diagram, at least one photoelectric component 17 converts light energy into electric energy, and at least one thermoelectric component 18 converts heat energy into electric energy, can be fixedly mounted on the periphery of the uniform light layer 15. Furthermore, a preferred structural configuration embodiment is one whereby the periphery of the uniform light layer 15 is provided with the light transmitting material 16 to cover the uniform light layer 15, the photoelectric components 17, and the thermoelectric components 18.

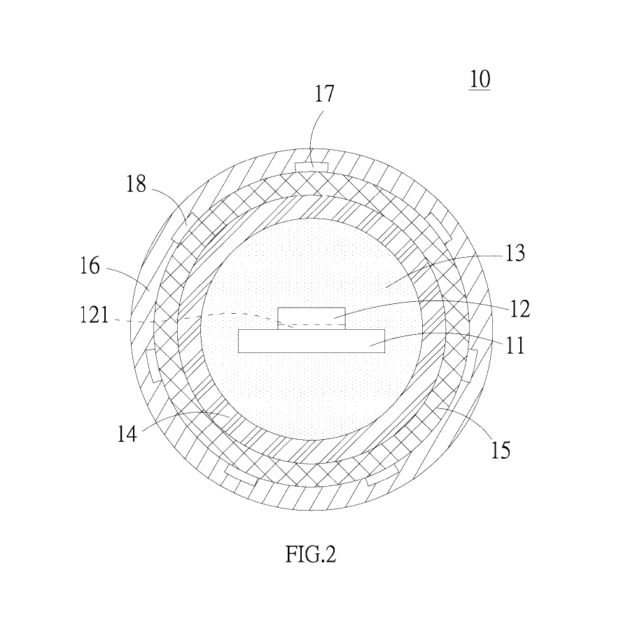

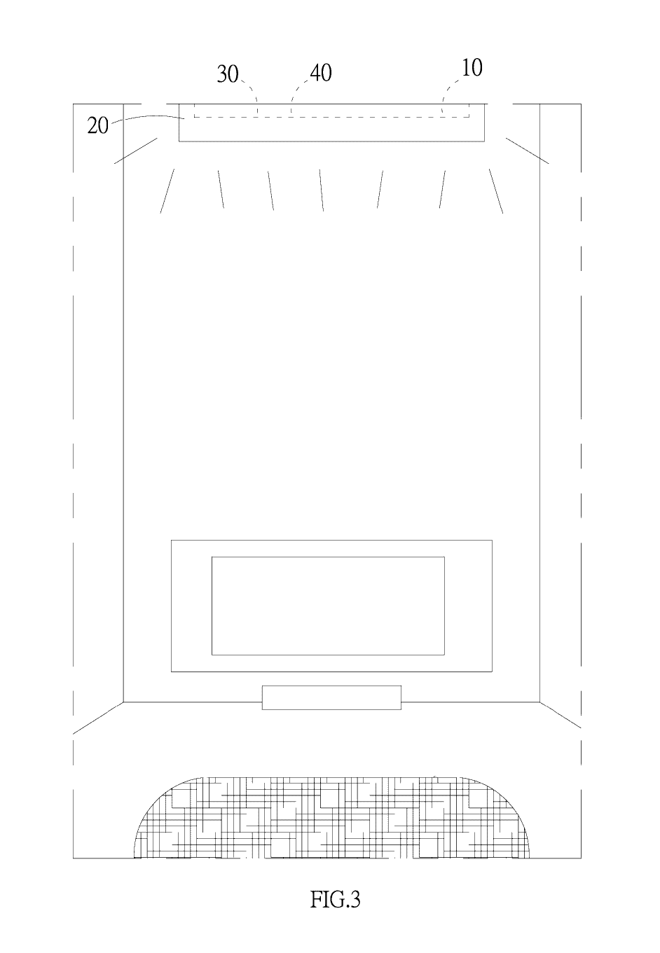

Referring to FIG. 2 and FIG. 3, which show the lighting device disclosed in the present invention basically comprising: a light holder 20, at least one strip light 10, and a control module 30, wherein:

Each of the strip lights 10 is mounted on the light holder 20, and at least one light emitting diode 12 is mounted on the transparent baseplate 11 of each of the strip lights 10. Each of the light emitting diodes 12 is fixedly mounted on the transparent baseplate 11 through at least one conductive film 121. In addition, the transparent baseplate 11 and the periphery of each of the light emitting diodes 12 are covered by the protective layer 13 formed by hardening a first plasticized material having light transmittance. The periphery of the protective layer 13 is covered by the fluorescent layer 14 made up from fluorescent powder, and the periphery of the fluorescent layer 14 is covered by the uniform light layer 15 formed by hardening a second plasticized material having light transmittance. The periphery of the uniform light layer 15 is fixedly mounted with at least one photoelectric component 17 that converts light energy into electric energy, and at least one thermoelectric component 18 that converts heat energy into electric energy.

The control module 30 is electrically connected to each of the light emitting diodes 12, each of the photoelectric components 17, and each of the thermoelectric components 18. The control module 30 enables connecting to an external power source and the power sources produced by each of the photoelectric components 17 and each of the thermoelectric components 18. Moreover, the control module 30 controls whether or not an electric current flows through each of the light emitting diodes 12.

Accordingly, the present invention achieves providing a lighting device capable of producing a 360-degree omnidirectional light emitting effect from the strip lights 10. In addition, the lighting device is further able, under the integrated operation of the control module 30 and each of the photoelectric components 17 and each of the thermoelectric components 18, to recover and convert the light energy and heat energy produced by the light emitting diodes 12 into electrical energy to supply that required for the lighting device to operate.

Furthermore, the entire lighting device is further installed with an electric power storage module 40, which is electrically connected to the control module 30 to enable storing electrical energy produced by each of the photoelectric components 17 and each of the thermoelectric components 18.

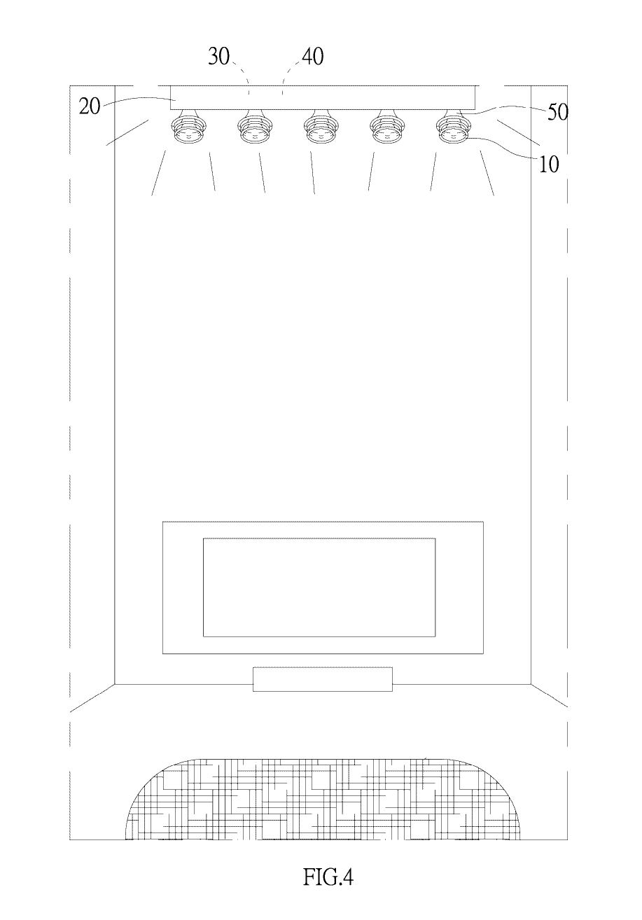

In actual use, as depicted in FIG. 3, in the lighting device of the present invention, the strip lights 10 are directly mounted on the light holder 20, or as depicted in FIG. 4, at least one set of lamp brackets 50 is installed to the light holder 20, and at least one strip light 10 is fitted to each of the lamp brackets 50, thereby increasing the effectiveness to vary the models of the entire lighting device or produce different functionalities. It is understood that the preferred structural configuration embodiment is one whereby the entire lighting device is further fitted with the electric power storage module 40 electrically connected to the control module 30, and at least one set of lamp brackets 50 is installed to the light holder 20, with at least one strip light 10 fitted to each of lamp brackets 50.

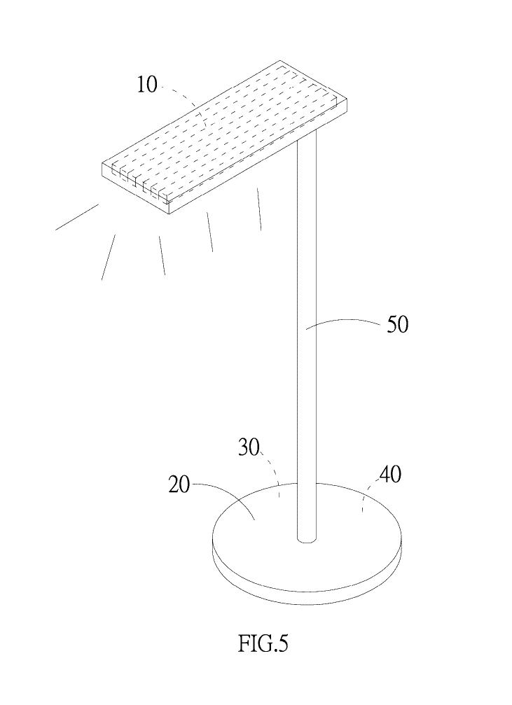

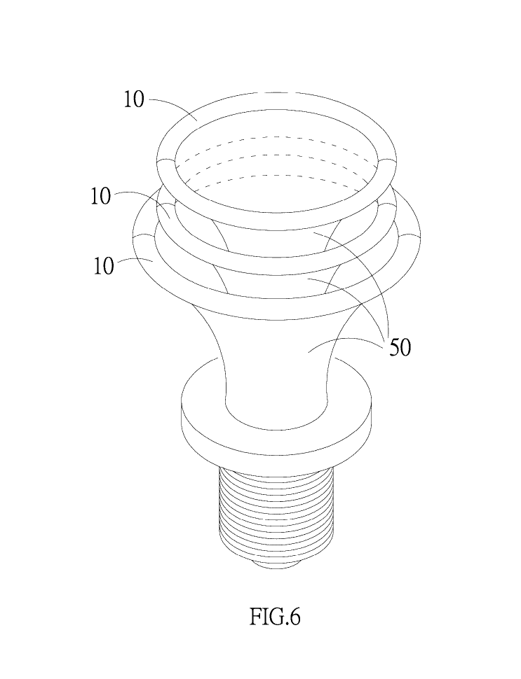

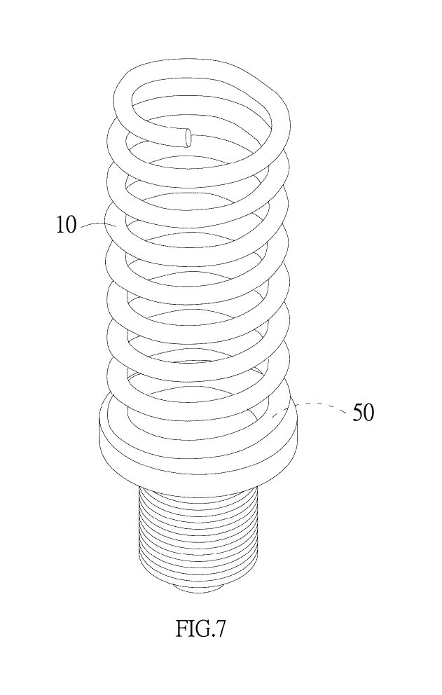

In the embodiments depicted in FIG. 3 and FIG. 4, the product models shown of the aforementioned lighting device can be configured as ceiling lights or wall lights. It is understood that, through modification of the shape of the lamp bracket 50, the entire lighting device can also be configured as a table lamp model, as depicted in FIG. 5. Moreover, the strip lights 10 can even be adapted to wrap around to form a concentric multi-ringed circular shape, as depicted in FIG. 6, or each of the strip lights 10 can be made to wrap around to form a helical shape, as depicted in FIG. 7. Accordingly, the strip lights 10 can be adapted to form light panels, light modules, or even light bulbs for application in different product models of lighting devices.

Similarly, as depicted in FIG. 2, the periphery of the uniform light layer 15 of each of the aforementioned strip lights 10 can be further provided with the light transmitting material 16 to cover the uniform light layer 15, the photoelectric components 17, and the thermoelectric components 18. Moreover, the aforementioned light transmitting material 16 is selected to be either glass or silicon.

The aforementioned control module 30 is an electrically connected structure comprising a starter unit, a detection unit, a computing unit, a compensation unit, a wireless signal receiving unit, and a voltage-stabilizing unit. The control module 30 primarily uses the starter unit to switch on a power source, and the detection unit detects whether or not the entire lighting device is in a state of utilizing power. The computing unit computes the insufficient quantity of electricity for the entire lighting device. The compensation unit enables changing the power supply to that supplied by the mains power supply according to the insufficient quantity of electricity computed by the computing unit, thereby enabling achieving an operating state of minimum usage of the mains power supply. Furthermore, the wireless signal receiving unit even enables receiving control signals from a remote control unit, a smart cell phone, or a tablet computer, thereby achieving remote wireless remote control effectiveness.

Compared to the prior art, apart from providing a 360-degree omnidirectional light source illumination effect, the strip lights disclosed by the present invention can be further adapted to present non-linear structural configurations, whereby the strip lights are configured to form light panels, light modules, or even light bulbs for application in different product models of lighting devices. In particular, through the integrated operation of each of the photoelectric components, each of the thermoelectric components, and the electric power storage module, light energy and heat energy produced by the light emitting diodes are recovered and converted into electrical energy to supply that required for the lighting device to operate, which further accentuates the energy saving and power saving effectiveness of the lighting device.

In conclusion, the present invention provides a preferred practicable strip light and lighting device application thereof. Accordingly, a new patent application is proposed herein. The technical contents of the present invention and technical features thereof are as disclosed above.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A strip light, comprising:
a transparent baseplate, the transparent baseplate is a flexible baseplate having light transmittance;
at least one light emitting diode, each of the light emitting diodes is fixedly mounted to the transparent baseplate through at least one conductive film;
a protective layer, the protective layer correspondingly covers the transparent baseplate and the periphery of each of the light emitting diodes, the protective layer is formed by hardening a first plasticized material having light transmittance;
a fluorescent layer, the fluorescent layer is made up from fluorescent powder, correspondingly covers the periphery of the protective layer;
a uniform light layer, the uniform light layer is formed by hardening a second plasticized material having light transmittance, correspondingly covers the periphery of the fluorescent layer.

2. The strip light according to claim 1, wherein a light transmitting material covers the periphery of the uniform light layer of the strip light.

3. The strip light according to claim 1, wherein at least one photoelectric component is fixedly mounted on the periphery of the uniform light layer of the strip light.

4. The strip light according to claim 1, wherein at least one thermoelectric component is fixedly mounted on the periphery of the uniform light layer of the strip light.

5. The strip light according to claim 1, wherein at least one of the photoelectric components and at least one of the thermoelectric components are fixedly mounted on the periphery of the uniform light layer of the strip light.

6. The strip light according to claim 1, wherein at least one of the photoelectric components and at least one of the thermoelectric components are fixedly mounted on the periphery of the uniform light layer of the strip light; the periphery of the uniform light layer is provided with the light transmitting material to cover the uniform light layer, the photoelectric components, and the thermoelectric components.

7. The strip light according to claim 1, wherein each of the conductive films is indium tin oxide having light transmittance.

8. The strip light according to claim 1, wherein each of the light emitting diodes is a semiconductor wafer cutting.

9. The strip light according to claim 1, wherein the transparent baseplate material is selected to be either a gallium nitride baseplate or a sapphire baseplate.

10. The strip light according to claim 1, wherein the protective layer is formed by hardening either silicone or resin.

11. The strip light according to claim 1, wherein fluorescent powder is added to the uniform light layer.

12. The strip light according to claim 1, wherein the uniform light layer is formed by hardening either silicone or optical material.

13. The strip light according to claim 1, wherein each of the light emitting diodes is die bonded to the transparent baseplate through wafer bonding.

14. The strip light according to claim 13, wherein the wafer bonding is either direct bonding or glue bonding.

15. The strip light according to claim 1, wherein the light transmitting material is selected to be either glass or silicon.

16. A lighting device, comprising:
a light holder;
at least one strip light, each of the strip lights is mounted on the light holder, and each of the strip lights is provided with a transparent baseplate having at least one light emitting diode mounted thereon;
each of the light emitting diodes is fixedly mounted on the transparent baseplate through at least one conductive film, and a protective layer, formed by hardening a first plasticized material having light transmittance, further covers the transparent baseplate and the periphery of each of the light emitting diodes, a fluorescent layer, which is made up from fluorescent powder, covers the periphery of the protective layer, a uniform light layer, formed by hardening a second plasticized material having light transmittance covers the periphery of the fluorescent layer, at least one photoelectric component and at least one thermoelectric component are fixedly mounted on the periphery of the uniform light layer;
a control module, the control module is electrically connected to each of the light emitting diodes, each of the photoelectric components, and each of the thermoelectric components to enable connecting to an external power source and the power sources produced by each of the photoelectric components and each of the thermoelectric components, moreover, the control module further controls whether or not an electric current flows through each of the light emitting diodes.

17. The lighting device according to claim 16, wherein at least one set of lamp brackets is installed to the light holder of the lighting device, and at least one strip light is fitted to each of the lamp brackets.

18. The lighting device according to claim 16, wherein the lighting device is further installed with an electric power storage module that is electrically connected to the control module.

19. The lighting device according to claim 16, wherein the lighting device is further installed with the electric power storage module that is electrically connected to the control module, and at least one set of the lamp brackets is installed to the light holder, with at least one strip light fitted to each of lamp brackets.

20. The lighting device according to claim 16, wherein the periphery of the uniform light layer of each of the strip lights is provided with a light transmitting material that covers the uniform light layer, the photoelectric components, and the thermoelectric components.

21. The lighting device according to claim 20, wherein the light transmitting material is selected to be either glass or silicon.

22. The lighting device according to claim 17, wherein each of the strip lights wrap around to assume a ring form.

23. The lighting device according to claim 17, wherein each of the strip lights wrap round to assume a helical form.

24. The lighting device according to claim 16, wherein the control module is an electrically connected structure comprising a starter unit, a detection unit, a computing unit, a compensation unit, a wireless signal receiving unit, and a voltage-stabilizing unit.
